(19) United States
(12) Patent Application Publication
(10) Pub. No.: US 2022/0189336 A1
(43) Pub. Date: Jun. 16, 2022

(54) Dance Instruction and Learning Mats

(71) Applicant: BTR BREAKIN LLC, Las Vegas, NV (US)

(72) Inventor: Jason Ryan Guerpo, Las Vegas, NV (US)

(21) Appl. No.: 17/350,976

(22) Filed: Jun. 17, 2021

Related U.S. Application Data
(60) Provisional application No. 63/126,084, filed on Dec. 16, 2020.

(51) Int. Cl. G09B 19/00; A63B 21/00

(52) U.S. Cl. CPC G09B 19/0015; A63B 2244/22; A63B 21/4037

(57) ABSTRACT

Dance instruction and learning mats in accordance with embodiments of the invention are provided. In one embodiment, a dance instruction mat includes a hexagon having a plurality of corners, where each of the plurality of corners is associated with a number and a plurality of midpoints, where each of the plurality of midpoints is associated with a number, a spin plate located at the center of the hexagon, where the spin plate is configured to rotate, and a plurality of directional lines connecting the plurality of corners and midpoints to a center of the mat.

### CROSS-REFERENCE TO RELATED APPLICATIONS

This application claims priority to U.S. Provisional Patent Application No. 63/126,084 entitled “Breakin Sensory Training Mat,” filed on Dec. 16, 2020, the disclosure of which is incorporated herein by reference.

### FIELD OF INVENTION

The present invention is generally related to mats and more specifically to dance instruction and leaning mats.

### BACKGROUND

Dancers range from people just beginning to learn dance basics to fitness enthusiasts to amateur and professional dancers. Learning to dance can involve developing a myriad of skills. For example, dancers may need to develop balance, strength, coordination, and total body awareness. They may also need to gain an understanding of angles, spatial intelligence, and knowledge of musical timing.

Breakin, also known as “break dancing,” is a sport-art dance form. It originated in the 1970s on the streets of New York City. Breakin requires first and foremost creativity and self-expression, followed by athleticism. This sport-art dance form is infused with influences from capoeira, gymnastics, kung-fu, American jazz, and Latin dance.

### SUMMARY OF THE INVENTION

Dance instruction and learning mats in accordance with embodiments of the invention are disclosed. The various embodiments of the present dance instruction and learning mats contain several features, no single one of which is solely responsible for their desirable attributes. Without limiting the scope of the present embodiments, the more prominent features of the dance instruction and learning mats will now be discussed below. In particular, the present dance instruction and learning mats will be discussed in the context of break dancing. However, the use of the mats as applied to break dancing is merely exemplary and various other instruction and learning mats may be utilized for other dance forms as appropriate to the requirements of a specific application in accordance with various embodiments of the invention. After considering this discussion, and particularly after reading the section entitled “Detailed Description,” one will understand how the features of the present embodiments provide the advantages described here.

In a first aspect, a dance instruction mat is provided, the dance instruction mat including a hexagon having a plurality of corners, where each of the plurality of corners is associated with a number and a plurality of midpoints, where each of the plurality of midpoints is associated with a number, a spin plate located at the center of the hexagon, where the spin plate is configured to rotate, and a plurality of directional lines connecting the plurality of corners and midpoints to a center of the mat.

In an embodiment of the first aspect, the numbers associated with the plurality of corners and the numbers associated with the plurality of midpoints are arranged from 1 to 12 in a clockwise direction to provide directional awareness.

In another embodiment of the first aspect, the numbers associated with the plurality of corners are odd numbers 1, 3, 5, 7, 9, and 11.

In another embodiment the first aspect, the numbers associated with the plurality of midpoints are even numbers 2, 4, 6, 8, 10, and 12.

In another embodiment of the first aspect, the numbers associated with the plurality of corners and midpoints are arranged to form a clock face on the hexagon for placement of at least one body part.

In another embodiment of the first aspect, the center of the mat further comprises a diamond having a top corner, a bottom corner, a first side corner, and a second side corner.

In another embodiment of the first aspect, the plurality of directional lines includes a first vertical directional line connecting the midpoint number 12 with the top corner of the diamond, a first diagonal directional line connecting the corner number 1 with the first side corner of the diamond, a first horizontal directional line connecting the corner number 3 with the first side corner of the diamond, a second diagonal directional line connecting the corner number 5 with the first side corner of the diamond, a second vertical directional line connecting the midpoint number 6 with the bottom corner of the diamond, a third diagonal directional line connecting the corner number 7 with the second side corner of the diamond, a second horizontal line connecting corner number 9 with the second side corner of the diamond, and a fourth diagonal directional line connecting corner number 11 with the second side corner of the diamond for placement of at least one body part.

In another embodiment of the first aspect, the mat further comprises a plurality of secondary directional lines having a first secondary directional line that connects the corner number 1 to the first horizontal directional line, a second secondary directional line that connects the corner number 5 to the first horizontal directional line, a third secondary directional line that connects the corner number 7 to the second horizontal directional line, and a fourth secondary directional line that connects the corner number 11 to the second directional line for placement of at least one body part.

In another embodiment of the first aspect, the plurality of directional lines delineates sections for placement of at least one body part.

In another embodiment of the first aspect, the mat further comprises a plurality of dots for placement of at least one body part.

In another embodiment of the first aspect, the plurality of dots are arranged in a circle around the diamond, wherein a first dot is at the top corner of the diamond and a second dot is at the bottom corner of the diamond.

In another embodiment the first aspect, the spin plate is located within the diamond center.

In another embodiment of the first aspect, the base plate attaches to the mat using an attachment mechanism.

In another embodiment of the first aspect, the spin plate is removable from the mat.

In another embodiment of the first aspect, the spin plate comprises a base plate, a rotational member, and a top plate.

In another embodiment of the first aspect, the rotational member comprises a rotational bearing device attached to the base plate.

In another embodiment of the first aspect, the spin plate has a height that is equal to or less than a height of the mat.

In another embodiment of the first aspect, the top plate has a diameter smaller than a diameter of the base plate.

In another embodiment of the first aspect, the top surface of the top plate comprises a cushioning material.

### BRIEF DESCRIPTION OF THE DRAWINGS

The various embodiments of the present dance instruction and learning mats will now be discussed in detail with an emphasis on highlighting the advantageous features. These embodiments depict the novel and non-obvious dance instruction and learning mat shown in the accompanying drawings, which are for illustrative purposes only. These drawings include the following figures:

FIG. 1 is a top view of a dance instruction mat in accordance with an embodiment of the invention.

FIG. 2 is a disassembled, cross-sectional view of the removable spin plate illustrating the different members of the plate in accordance with an embodiment of the invention.

FIG. 3 is a cross-sectional view of the removable spin plate in attachment to the dance instruction mat in accordance with an embodiment of the invention.

FIG. 4 is cross-sectional view of the dance instruction mat without either the removable center section or the removable spin plate.

FIG. 5 is a flow chart illustrating a dance move on at least one of the plurality of sections in accordance with an embodiment of the invention.

FIG. 6 is a flow chart illustrating a dance move on at least one of the directional lines in accordance with an embodiment of the invention.

FIG. 7 is a flow chart illustrating a dance move on at least one number on the clock face in accordance with an embodiment of the invention.

FIG. 8 is a low chart illustrating a dance move on the removable spin plate in accordance with an embodiment of the invention.

### DETAILED DESCRIPTION OF THE DRAWINGS

The following detailed description describes the present embodiments with reference to the drawings. In the drawings, reference numbers label elements of the present embodiments. These reference numbers are reproduced below in connection with the discussion of the corresponding drawing features.

Turning now to the drawings, dance instruction and learning mats (may be referred to as “dance instruction mats” or “mats”) in accordance with embodiments of the invention are illustrated. Dance instruction mats may include a hexagon having corners associated with numbers and midpoints also associated with numbers, as further described below. In many embodiments, the numbers associated with the corners and the numbers associated with the midpoints of the hexagon may be arranged from 1 to 12 in a clockwise direction to provide directional awareness, as further described below. In various embodiments, dance instruction mats may also include a spin plate located at the center of the hexagon and directional lines connecting the corners and midpoints of the hexagon to a center of the mats, as further described below. In some embodiments, the center of the mat may include a diamond (may also be referred to as a “center diamond”) having corners, as further described below.

In a variety of embodiments, the various components including the directional lines may be used to receive a user's body part (e.g., a hand, a foot, a knee, an elbow, etc.) in order to perform a dance move, as further described below. For example, to train footwork using the mat, the user may first place both feet at the corners of the center diamond, as further described below. In some embodiments, the user may perform a cross step dance move by moving the left foot across the planted right foot, balancing on the planted right foot, and then stepping the left foot onto the right horizontal directional line. In some embodiments, the numbers arranged in a clock-like pattern may be used to provide directional awareness, as further described below. To train for circular footwork, the user may place their hands into the various sections within the hexagon as the feet travel around the mat on the numbers located at the corners and edge midpoints of the hexagon, as further described below.

In some embodiments, a section of the mat may have a top surface material that allows for a user to perform head spins directly on the mat. In various embodiments, a section of the mat may be configured to receive a removable spin plate (may also be referred to as a “spin plate” or “plate”), wherein the spin plate may be attached to the mat by an attachment mechanism. The attachment mechanism may include, but is not limited to, tape, hook-and-loop fasteners (e.g., Velcro tape), bolts, screws or a pair of mating connectors or fasteners, etc. In several embodiments, a removable spin plate may be attached to a mat and be configured to receive at least one body part on the plate to perform a dance move. For example, by placing one's head on the removable spin plate, a user can train for a headstand move. In a variety of embodiments, at least another body part may be placed on the at least one of eight dots to perform a spinning dance move. For example, a spin plate power move can be performed by performing a headstand with the top of the head centered on the spin plate, placing hands on the dots around the spin plate, and powering the spinning move with the user's upper body while the lower body remains stable. A dance instruction and learning mat for performing dance moves in accordance with embodiments of the invention are further discussed below.

Dance Mats with Removable Section

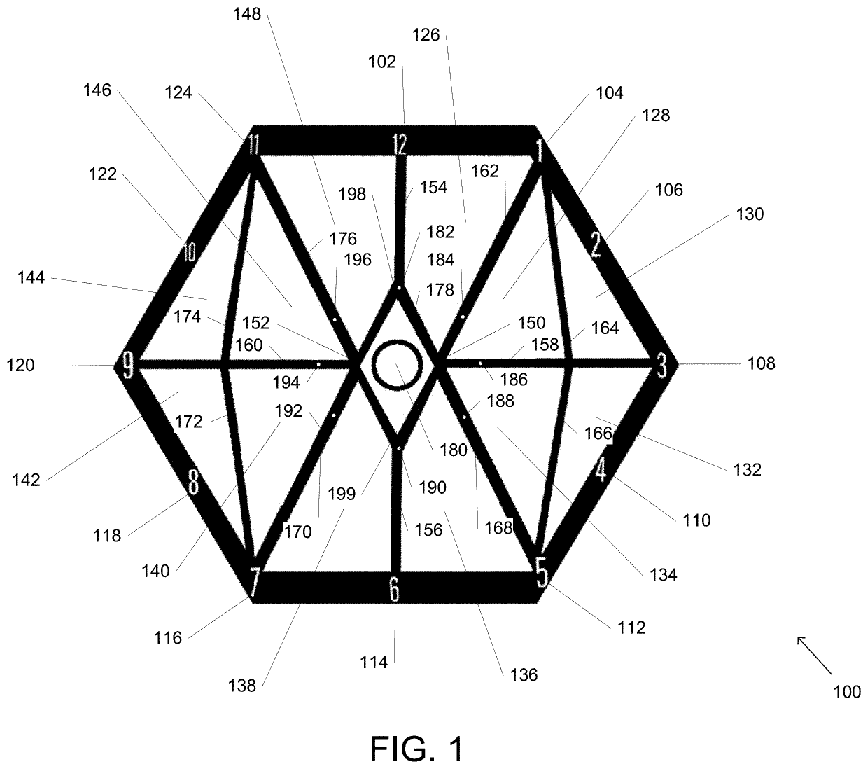

Mats may include numbers, various sections, and directional lines for dance instructions. A top view of a mat in accordance with an embodiment of the invention is illustrated in FIG. 1. In many embodiments, a mat 100 may be a hexagon mat having corners and edge midpoints where edge midpoints may be defined as points between two corners. The mat 100 may include numbers presented in a clock-face arrangement with the numbers located at the corners and edge midpoints of the hexagon, as further described below. For example, the number twelve may be located at the top of the mat 100 (may also be referred to as “a first edge midpoint” or “top edge midpoint” 102). The number one may be located at a first corner 104 of the mat 100. The number two may be located at a second edge midpoint 106. The number three may be located at a second corner 108 (may also be referred to as “right corner” 108). The number four may be located at a third edge midpoint 110. The number five may be located a third corner 112 of the mat 100. The number six may be located at a fourth midpoint 114 (may also be referred to as “bottom edge midpoint” 114). The number seven may be located at a fourth corner 116 of the mat 100. The number eight may be located at a fifth edge midpoint 118. The number nine may be located at a fifth corner 120 (may also be referred to as “left corner” 120). The number ten may be located at a sixth edge midpoint 122. The number eleven may be located at a sixth corner 124 of the mat 100.

In reference to FIG. 1, the mat 100 may also include a first vertical directional line 154 that connects the first edge midpoint 102 to a top corner 198 of a center diamond 178. The mat 100 may also include a second vertical directional line 156 that connects the fourth edge midpoint 114 to a bottom corner 199 of the center diamond 178. The mat 100 may also include a first horizontal directional line 158 that connects the second corner 108 to a first side corner 150 of the center diamond 178. The mat 100 may also include a second horizontal directional line 160 that connects the fifth corner 120 to the second side corner 152 of the center diamond 178. The mat 100 may also include a first diagonal directional line 162 that connects the first corner 104 to also the first side corner 150 of the center diamond 178. The mat 100 may also include a second diagonal directional line that connects the third corner 112 to the first side corner 150 of the center diamond 178. The mat 100 may also include a third diagonal directional line 170 that connects the fourth corner 116 to the second side corner 152 of the center diamond 178. The mat 100 may also include a fourth diagonal directional line 176 that connects the sixth corner 124 to the second side corner 152 of the center diamond 178. The mat 100 may also include a first secondary angled directional line 164 that connects the first corner 104 to the first horizontal directional line 158. The mat 100 may also include a second secondary angled directional line 166 that connects the third corner 112 to the first horizontal directional line 158.

In further reference to FIG. 1, in many embodiments, a meeting point of the first and second secondary angled directional lines 164, 166 on the first horizontal line 158 may be closer to the second corner 108 than to the first side corner 150. The mat 100 may also include a third secondary angled directional line 172 that connects the fourth corner 116 to the second horizontal directional line 160. The mat 100 may also include a fourth secondary angled directional line 174 that connects the sixth corner to the second horizontal directional line 160. In various embodiments, a meeting point of the third and fourth secondary angled directional lines 172, 174 on the second horizontal line 160 may be closer to the second corner 120 than the first side corner 152.

In further reference to FIG. 1, a plurality of sections may be delineated by the directional lines, as described above. For example, a first quadrilateral section 126 may be defined by one edge of the diamond 178, the first vertical directional line 154, the first diagonal directional line 162, and the edge between the first edge midpoint 102 and the first corner 104. A second quadrilateral section 136 may be defined by one edge of the diamond 178, the second vertical directional line 156, the second diagonal directional line 168, and the edge between the fourth edge midpoint 114 and the third corner 112. A third quadrilateral section 138 may be defined by one edge of the diamond 178, the second vertical directional line 156, the third diagonal directional line 170, and the edge between the fourth edge midpoint 114 and the fourth corner 116. A fourth quadrilateral section 148 may be defined by one edge of the diamond 178, the first vertical directional line 154, the fourth diagonal directional line 176, and the edge between the first edge midpoint 102 and the sixth corner 124.

In further reference to FIG. 1, a first major triangular section 128 may be defined by the first diagonal directional line 162, the first secondary angled directional line 164, and the first horizontal directional line 158. A first minor triangular section 130 may be defined by the first secondary angled directional line 164, and the first horizontal directional line 158, and the edge between the first corner 104 and the second corner 108. A second major triangular section 134 may be defined by the second diagonal directional line 168, the second secondary angled directional line 166, and the first horizontal directional line 158. A second minor triangular section 132 may be defined by the second secondary angled directional line 166, and the first horizontal directional line 158, and the edge between the second corner 106 and the third corner 112. A third major triangular plurality of section 140 may be defined by the third diagonal directional line 170, the third secondary angled directional line 172, and the second horizontal directional line 160. A third minor triangular plurality of section 142 may be defined by the third secondary angled directional line 172, and the second horizontal directional line 160, and the edge between the fourth corner 116 and the fifth corner 120. A fourth major triangular plurality of section 146 may be defined by the fourth diagonal directional line 176, the fourth secondary angled directional line 174, and the second horizontal directional line 160. A fourth minor triangular plurality of section 144 may be defined by the fourth secondary angled directional line 174, and the second horizontal directional line 160, and the edge between the fifth corner 120 and the six corner 124.

In some embodiments, the center diamond 178 may have a top surface material that allows for a user to spin directly on the diamond on the mat. In many embodiments, the center diamond 178 may include a removable center section 180. In some embodiments, the center diamond 178 may be surrounded in a circular fashion by at least eight dots, serving as guidance markers for head spin and freezing dance moves. For example, a first dot 182 may be located at the top corner 198 of the diamond 178. A second dot 190 may be located on the bottom corner 199 of the diamond 178. A third dot 184 may be located on the first diagonal directional line 184. A fourth dot 186 may be located on the first horizontal directional line 158. A fifth dot 188 may be located on the second diagonal directional line 168. A sixth dot 192 may be located on the third diagonal directional line 170. A seventh dot 194 may be located on the second horizontal directional line 160. An eighth dot 196 may be located on the fourth diagonal directional line 176. In several embodiments, the removable center section 180 can be replaced by a removable spin plate, as further described below.

Although specific dance mats with instructional numbers, plurality of sections, directional lines, dots, and removable spin plates are discussed above with FIG. 1, any variety of dance instruction and learning mats incorporating instructional numbers, plurality of sections, directional lines, dots, and removable spin plates may be used in accordance with embodiments of the invention including placing such removable spin plates at various locations on a dance instruction mat. Spin plates in accordance with embodiments of the invention are further discussed below.

### Removable Spin Plates

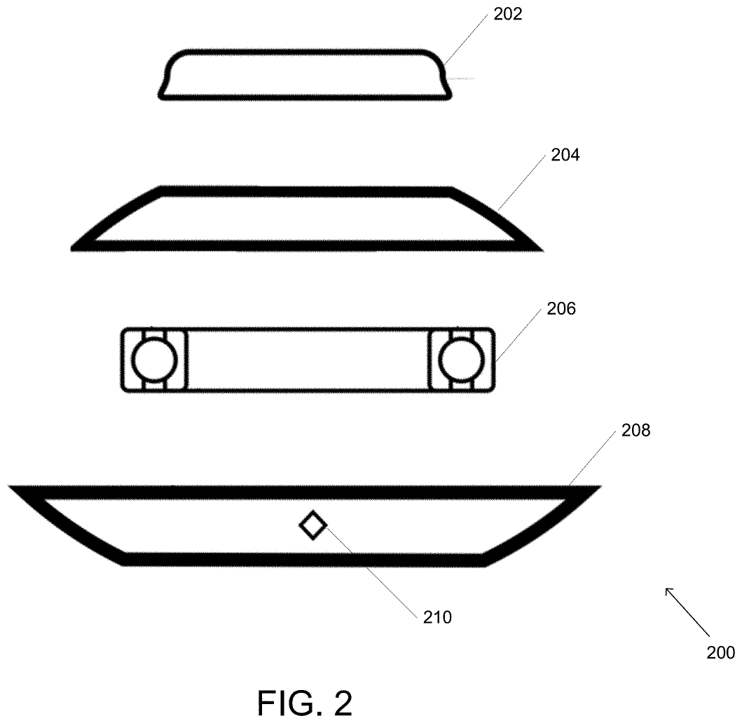

A disassembled, cross-sectional view of a removable spin plate is illustrated in FIG. 2. The removable spin plate 200 may include a bottom plate 208, a rotational member 206, and a top plate 204. In many embodiments, the bottom plate 208 may include at least one first attachment mechanism 210. The attachment mechanism may include, but is not limited to, a hook-and-loop fastener (e.g., Velcro tape), bolts, screws or a half of a pair of mating connectors or fasteners, etc. In various embodiments, in between the bottom plate 208 and the top plate 204 may be a rotational member 206. In several embodiments, the rotational member 206 may be a rotational bearing device. Further, the top plate 204 may include a cushioning material top surface 202 to allow for comfortable placement of a user's body part such as, but not limited to, a user's head or hand.

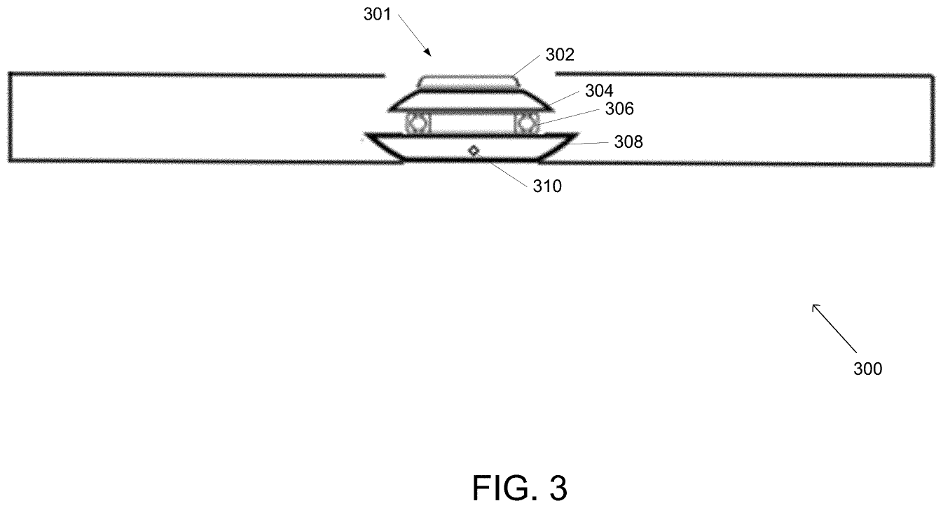

In many embodiments, an attachment mechanism may be used to attach an assembled spin plate to the mat. A cross-sectional view of the assembled spin plate attached to a mat is illustrated in FIG. 3. The assembled spin plate 301 may replace the removable center section of a mat 300. For example, a diameter of the bottom plate 310 may be similar to the diameter of the removable center section, allowing the bottom plate 310 to fit snugly into the circular location. The bottom plate 310 may have at least one first attachment mechanism, attaching the bottom plate 310 to the mat 300. As described above, the attachment mechanism may include, but is not limited to, a hook-and-loop fastener (e.g., Velcro tape), bolts, screws or a half of a pair of mating connectors or fasteners. The diameter of the top plate 304 may be smaller than the diameter of the bottom plate 310, allowing it to rotate on top of the rotating member 306 without sliding against the mat 300. The height of the assembled spin plate 301 may be similar to the thickness of the mat 300 such that the top of the cushioning material top surface 302 may be aligned with the top of the mat 300.

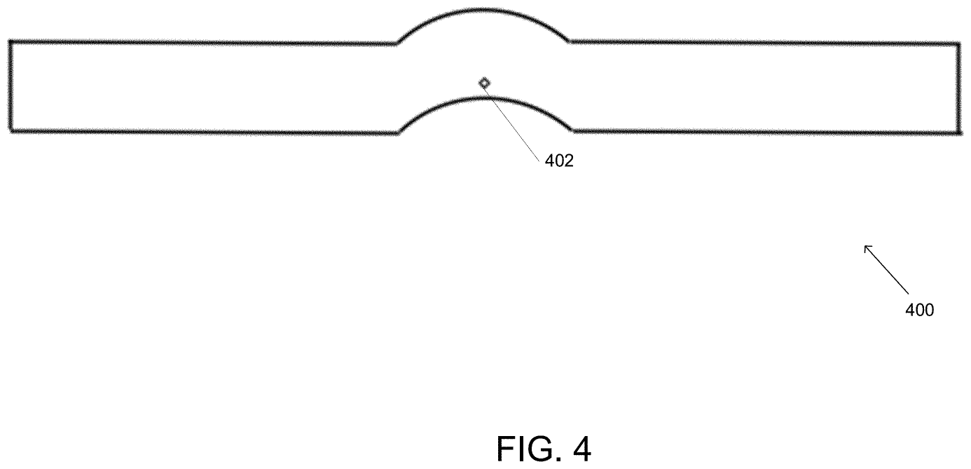

A cross-sectional view of a mat without an assembled spin plate is illustrated in FIG. 4. The mat 400 may include a second attachment mechanism 402 to attach a removable spin plate to the mat 400. The second attachment mechanism 402 may include, but is not limited to, a hook-and-loop fastener (e.g., Velcro tape), bolts, screws or a half of a pair of mating connectors or fasteners. In many embodiments, the second attachment mechanism 402 may be configured or receive a first attachment mechanism of the spin plate, as described above. In some embodiments, the second and first attachment mechanisms may complement each other to allow for a spin plate to be attached to the mat.

Although specific removable spin plates are discussed above with FIGS. 2-4, any variety of spin plates may be used in accordance with embodiments of the invention including placing such removable spin plates at various locations on a dance instruction mat. In several embodiments, the removable spin plate may be used in conjunction with a top surface material on a section of the mat that allows for spinning directly on the mat. In some embodiments, there may be no removable spin plate if a section of the mat, such as the center diamond, is composed of a top surface material that allows for spinning directly on the mat. Processes for instructing dance moves in accordance with embodiments of the invention are discussed below.

### Processes for Instructional Dance Movements

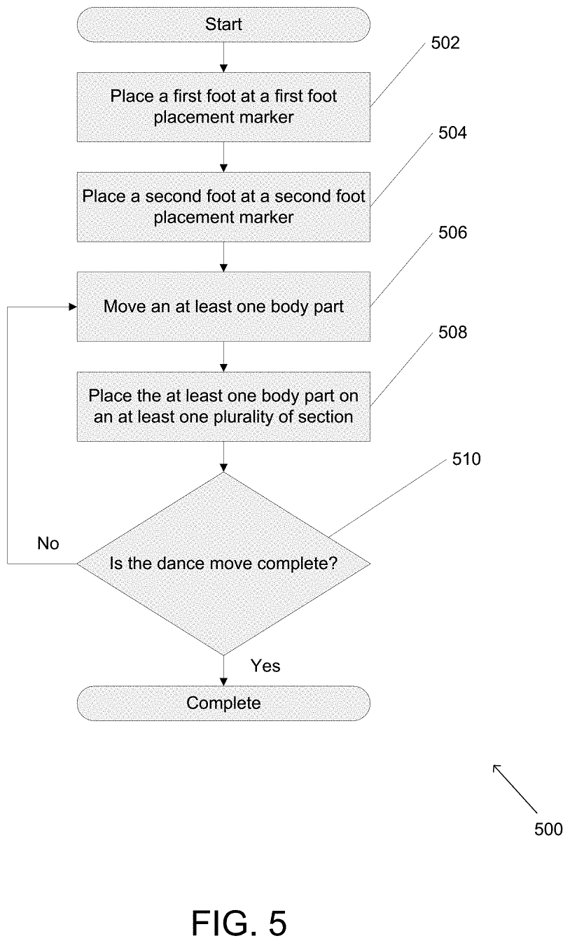

Users may use the dance instruction and learning mats to perform dance moves such that at least one plurality of section, at least one directional or secondary directional line, or at least one number on a clock pattern receives at least one body part (e.g., a hand, a foot, a knee, an elbow, etc.). A process for performing a dance move utilizing the plurality of sections in accordance with an embodiment of the invention is illustrated in FIG. 5. The process 500 may include placing (502) a first foot at a first foot placement marker and placing (504) a second foot at a second foot placement marker. The process 500 may also include the user moving (506) at least one body part, such as a hand or a foot. The moved body part may be placed (508) on at least one plurality of sections. For example, a user may stay upright and a foot may step on and remain on at least one plurality of sections. In another example, a user may perform a knee drop, placing a knee on at least one plurality of sections. The process 500 may also include a determination (510) of whether the dance move is complete. If the move is not complete (510), the user may move (506) a body part again to perform the next step in the dance move. If the move is complete (510), the process 500 may be complete.

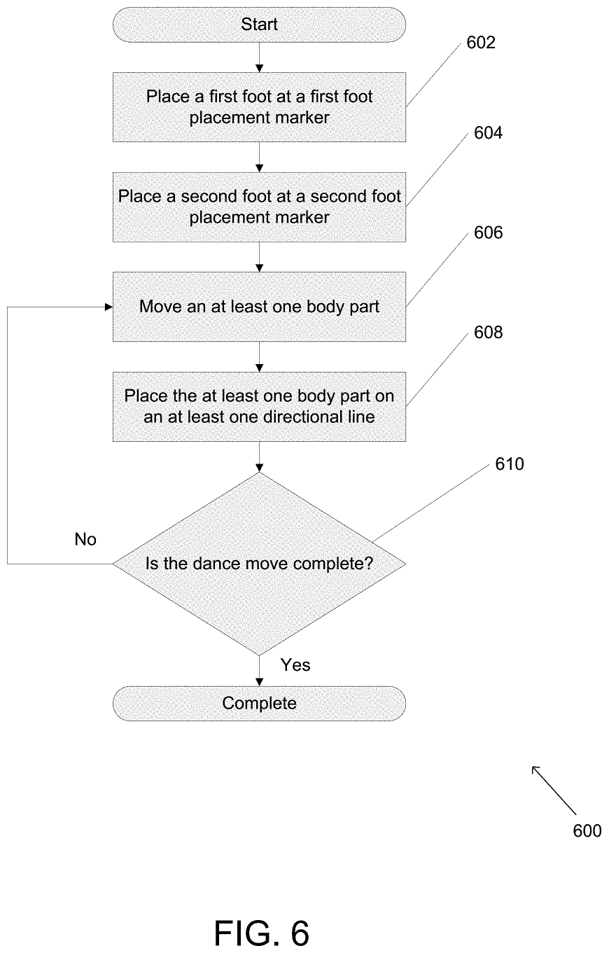

A user may also utilize the directional (or secondary directional) lines to perform a dance move. A process for performing a dance move using the directional lines in accordance with an embodiment of the invention is illustrated in FIG. 6. The process 600 may include a user placing (602) a first foot at a first foot placement marker and placing (604) a second foot at a second foot placement marker. The process 600 may also include the user moving (606) at least one body part, such as a hand or a foot. In many embodiments, the moved body part may be placed on at least one directional line. For example, a user may stay upright, perform a lunge dance step, crossing one foot over the other and step diagonally onto a diagonal directional line. The process 600 may further include a determination (610) as to whether the dance move is complete. If the move is not complete (610), the user may move (608) a body part again to perform the next step in the dance move. If the move is complete (610), the process 600 may be complete.

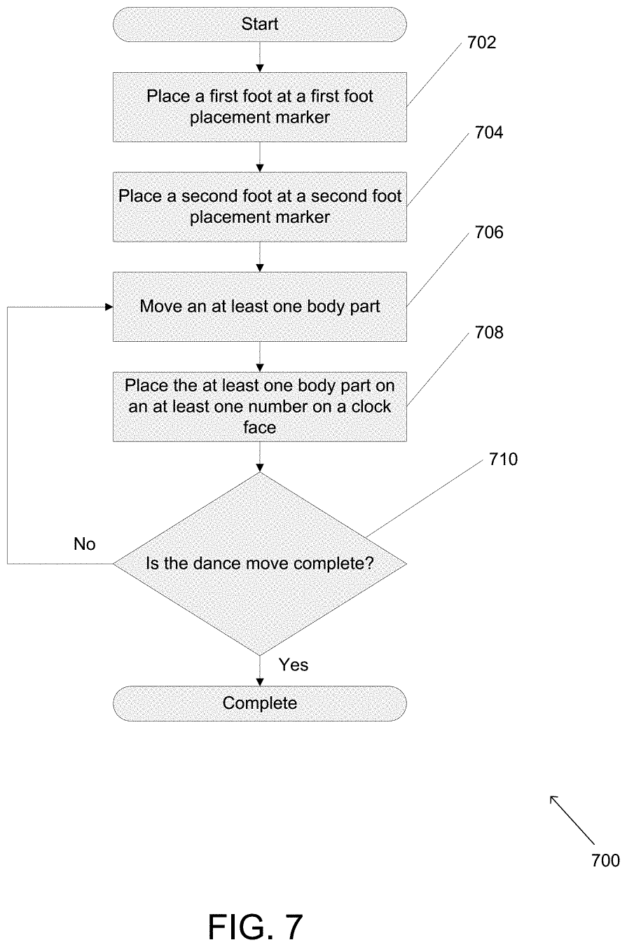

A user may also utilize numbers on the corners or edge midpoints to perform a dance move. A process for performing a dance move using one or more numbers in accordance with an embodiment of the invention is illustrated in FIG. 7. The process 700 may include placing (702) a first foot at a first foot placement marker and placing (704) a second foot at a second foot placement marker. The process 700 may also include the user moving (706) at least one body part, such as a hand or a foot. The process 700 may further include the user placing (708) the moved body part on one of the numbers on a clock face. For example, a user can perform a circular footwork dance move by being on all fours, placing the hands on the plurality of sections while moving the feet around the numbers at the corners and edge midpoints of the hexagon. The process 700 may also include a determination (710) of whether the dance move is complete. If the move is not complete (710), the user may move (706) a body part again to perform the next step in the dance move. If the move is complete (710), the process 700 may complete. Although specific processes for instructing dance moves using mats are discussed above with FIGS. 5-7, any variety of processes for instructing dance moves using mats may be used in accordance with embodiments of the invention. Instructing dance moves on removable spin plates in accordance with embodiments of the invention are further described below.

### Processes for Dance Movements on Removable Spin Plates

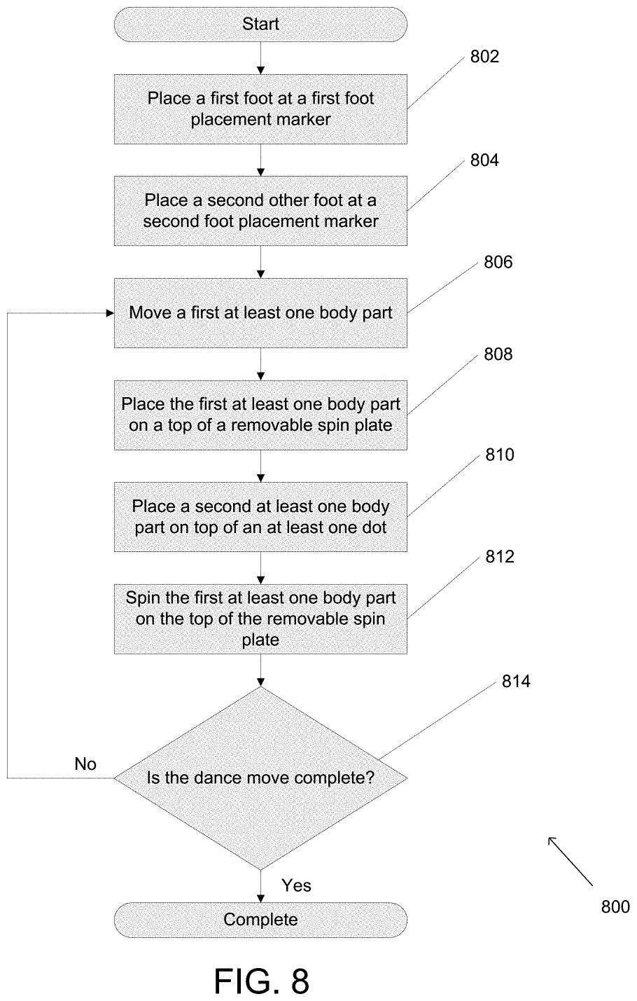

In many embodiments, users may use mats that replace the removable circular section of the mat by attaching a removable spin plate. A dance move can be performed on the attached removable spin plate. A process for performing a dance move utilizing the removable spin plate in accordance with an embodiment of the invention is illustrated in FIG. 8. The process 800 may include placing (802) a first foot at a first foot placement marker and placing (804) a second foot at a second foot placement marker. The process 800 may also include the user moving (806) at least one body part, such as a head or a hand. The process 800 may further include the moved body part being placed (808) on a top of a removable spin plate. For example, a user can flip upside down and place their head on the spin plate. In some embodiments, the process 800 may include a second body part being placed (810) on the top of at least one dot surrounding the spin plate. For example, two hands could be placed on two different dots to stabilize the user when a user's head is on the spin plate. The head and two hands may create a base balance position. A user may then perform a spinning dance move by spinning (812) the at least one body part, such as the head, on the top of the removable spin plate. The process 800 may include a determination (814) as to whether the dance move is complete. If the move is not complete (814), the user may move a body part again to perform the next step in the dance move. If the move is complete (814), the process 800 may be complete.

Although specific processes for instructing dance moves using mats with spin plates are discussed above with FIG. 8, any variety of processes for instructing dance moves using mats with spin plates may be used in accordance with embodiments of the invention. While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. A dance instruction mat comprising:
a hexagon comprising a plurality of corners, wherein each of the plurality of corners is associated with a number and a plurality of midpoints, wherein each of the plurality of midpoints is associated with a number;
a spin plate located at the center of the hexagon, wherein the spin plate is configured to rotate; and
a plurality of directional lines connecting the plurality of corners and midpoints to a center of the mat.

2. The dance instruction mat of claim 1, wherein the numbers associated with the plurality of corners and the numbers associated with the plurality of midpoints are arranged from 1 to 12 in a clockwise direction to provide directional awareness.

3. The dance instruction mat of claim 1, wherein the numbers associated with the plurality of corners are odd numbers 1, 3, 5, 7, 9, and 11.

4. The dance instruction mat of claim 3, wherein the numbers associated with the plurality of midpoints are even numbers 2, 4, 6, 8, 10, and 12.

5. The dance instruction mat of claim 4, wherein the numbers associated with the plurality of corners and midpoints are arranged to form a clock face on the hexagon for placement of at least one body part.

6. The dance instruction mat of claim 5, wherein the center of the mat further comprises a diamond having a top corner, a bottom corner, a first side corner, and a second side corner.

7. The dance instruction mat of claim 6, wherein the plurality of directional lines comprises:
a first vertical directional line connecting the midpoint number 12 with the top corner of the diamond;
a first diagonal directional line connecting the corner number 1 with the first side corner of the diamond;
a first horizontal directional line connecting the corner number 3 with the first side corner of the diamond;
a second diagonal directional line connecting the corner number 5 with the first side corner of the diamond;
a second vertical directional line connecting the midpoint number 6 with the bottom corner of the diamond;
a third diagonal directional line connecting the corner number 7 with the second side corner of the diamond;
a second horizontal line connecting corner number 9 with the second side corner of the diamond; and
a fourth diagonal directional line connecting corner number 11 with the second side corner of the diamond for placement of at least one body part.

8. The dance instruction mat of claim 7 further comprising a plurality of secondary directional lines comprising:
a first secondary directional line that connects the corner number 1 to the first horizontal directional line;
a second secondary directional line that connects the corner number 5 to the first horizontal directional line;
a third secondary directional line that connects the corner number 7 to the second horizontal directional line; and
a fourth secondary directional line that connects the corner number 11 to the second directional line for placement of at least one body part.

9. The dance instruction mat of claim 8, wherein the plurality of directional lines delineates sections for placement of at least one body part.

10. The dance instruction mat of claim 8 further comprising a plurality of dots for placement of at least one body part.

11. The dance instruction mat of claim 10, wherein the plurality of dots are arranged in a circle around the diamond, wherein a first dot is at the top corner of the diamond and a second dot is at the bottom corner of the diamond.

13. The dance instruction mat of claim 6, wherein a spin plate is located within the diamond center.

14. The dance instruction mat of claim 13, wherein the base plate attaches to the mat using an attachment mechanism.

15. The dance instruction mat of claim 14, wherein the spin plate is removable from the mat.

16. The dance instruction mat of claim 14, wherein the spin plate comprises a base plate, a rotational member, and a top plate.

17. The dance instruction mat of claim 16, wherein the rotational member comprises a rotational bearing device attached to the base plate.

18. The dance instruction mat of claim 13, wherein the spin plate has a height that is equal to or less than a height of the mat.

19. The dance instruction mat of claim 13, wherein the top plate has a diameter smaller than a diameter of the base plate.

20. The dance instruction mat of claim 13, wherein the top surface of the top plate comprises a cushioning material.
